(19) United States
(12) Patent Application Publication
(10) Pub. No.: US 2006/0041942 A1
(43) Pub. Date: Feb. 23, 2006

(54) System, method and computer program product for preventing spyware/malware from installing a registry

(75) Inventor: Jonathan L. Edwards, Portland, OR (US)

Correspondence Address: Zilka-Kotab, PC, P.O. BOX 721120, SAN JOSE, CA, 95172-1120, US

(73) Assignee: MCAFEE, INC.

(21) Appl. No.: 11/010,993

(22) Filed: Dec. 13, 2004

Related U.S. Application Data
(63) Continuation-in-part of application No. 10/876,524, filed on Jun. 24, 2004.
Application No. 10/876,524 is a continuation-in-part of application No. 10/876,523, filed on Jun. 24, 2004.

(51) Int. Cl. H04L 9/32

(52) U.S. Cl. 726/26

(57) ABSTRACT

A system, method and computer program product are provided. In particular, an attempt to make a change to a registry of a computer is first identified. Then, the change to the registry is conditionally prevented based on a set of rules.

### RELATED APPLICATION(S)

The present application is a continuation-in-part of an application filed Jun. 24, 2004 under application Ser. No. 10/876,524, and which is incorporated herein by reference. This application is further related to a co-pending application entitled “SYSTEM, METHOD, AND COMPUTER PROGRAM PRODUCT FOR TAILORING SECURITY RESPONSES FOR LOCAL AND REMOTE FILE OPEN REQUESTS” which was filed Jun. 24, 2004 under application Ser. No. 10/876,523, and which is also incorporated herein by reference.

### FIELD OF THE INVENTION

The present invention relates to computer networking, and more particularly to managing spyware and/or malware.

### BACKGROUND OF THE INVENTION

In the space of just a decade, the Internet, because it provides access to information, and the ability to publish information, in revolutionary ways, has emerged from relative obscurity to international prominence. Whereas, in general, an internet is a network of networks, the Internet is a global collection of interconnected local, mid-level, and wide-area networks that use the Internet Protocol (IP) as the network layer protocol. Whereas the Internet embraces many local- and wide-area networks, a given local- or wide-area network may or may not form part of the Internet.

As the Internet and its underlying technologies have become increasingly familiar, attention has become focused on Internet security and computer network security in general. With unprecedented access to information has also come unprecedented opportunities to gain unauthorized access to data, change data, destroy data, make unauthorized use of computer resources, interfere with the intended use of computer resources, etc. These opportunities have been exploited time and time again by many types of malware including, but is not limited to computer viruses, worms, Trojan horses, etc. As experience has shown, the frontier of cyberspace has its share of scofflaws, resulting in increased efforts to protect the data, resources, and reputations of those embracing intranets and the Internet.

Recently, some new types of software have emerged, collectively called “spyware.” Spyware, while not as malicious as the aforementioned conventional viruses, Trojan horses, etc., may still cause problems for computer users. For example, spyware may be designed to log keystrokes, track which websites a computer user visits, and/or transmit personal information to a third party.

In the context of the present description, the term spyware is further deemed to include other related types of similar software such as adware, dialer software, other equivalents, and/or any other software that is less malicious than conventional malware. For example, adware is typically designed to download and display advertisements on a screen of a computer, and can be very intrusive. Dialer software, on the other hand, is designed to redirect a dial-up Internet Service Provider (ISP) connection of a computer to a different, more expensive phone number, in exchange for access to something, typically pornography.

Often, this software is marketed as legitimate applications which the computer user ostensibly installs willingly. For example, a free music player application may be come bundled with adware and require that the adware be installed before the music player application will work. The owner of the adware conventionally pays the owner of the music player to include the adware.

Although some of these examples of spyware border on legitimacy, many of these applications are poorly written, and cause compatibility problems with other software. Moreover, spyware can be very intrusive, waste network bandwidth, and cause a slew of other problems.

While the distinguishing feature of malware such as a computer virus is still that it replicates from file to file, such malware has evolved from simply being pieces of code that replicate into tools to enable more targeted violations of computer security. This trend is seen most clearly in the existence of “zombie” networks. These networks come into being when a virus infects many computers which all then communicate to the malware author awaiting commands. Once the network is in place, it can be used for many nefarious deeds including launching denial of service attacks, sending SPAM, etc.

It is sometimes beneficial for a malware and/or spyware scanner product to contain a true “on-access scanner,” which scans files the instant they are created. Unfortunately, it is not possible for some products to incorporate such an on-access scanner. In these cases, the system is only protected by “on-demand scanning,” which is a scan that is run per a certain schedule, for example, once per day. Because such scanning happens infrequently, there is a sizeable window of opportunity for spyware and/or malware to cause harm.

There is thus a need for overcoming these and/or other problems associated with the prior art.

### SUMMARY

A system, method and computer program product are provided. In particular, an attempt to make a change to a registry of a computer is first identified. Then, the change to the registry is conditionally prevented based on a set of rules.

In one embodiment, the attempt to make the change to the registry may be received from an application program. Further, such attempt to make the change to the registry may involve a request to an operating system of the computer.

In another embodiment, the change may involve a write value operation, a change value operation, a delete value operation, a create subkey operation, a change subkey operation, etc.

Further, the rules may involve a name of a process requesting the change, a name of a key in the registry that is being changed, a name of a value in the registry that is being changed, a type of the change, data that is being written to the registry, etc. Still yet, the rules may further involve a key such as the following, for example:
HKLM\software\microsoft\windows\currentversion\run,
HKLM\SOFTWARE\Microsoft\Windows NT\CurrentVersion\Winlogon, and/or
HKLM\software\microsoft\windows\currentversion\explorer\browser helper objects.

In still yet another embodiment, the change may be prevented for precluding installation of spyware on the computer. Further, the change may be prevented for precluding installation of malware on the computer.

As an option, the registry may include a location on the computer for storing information including hardware that is attached to the computer, system options that have been selected, a configuration of memory of the computer, and/or application programs to be present when an operating system of the computer is started.

Strictly as an option, the foregoing technology may be utilized to counter terrorism.

### BRIEF DESCRIPTION OF THE DRAWINGS

FIG. 1 illustrates a network architecture, in accordance with one embodiment.

FIG. 2 shows a representative hardware environment that may be associated with the data server computers and/or end user computers of FIG. 1, in accordance with one embodiment.

FIG. 3 illustrates a method for preventing malware infection, in accordance with one embodiment.

FIG. 4 illustrates a method for defining a rule to prevent malware infection, in accordance with one embodiment.

FIG. 5 illustrates an exemplary graphical user interface for defining a rule to prevent malware infection, in accordance with one embodiment.

FIG. 6 illustrates a method for combating spyware, malware, etc., in accordance with one embodiment.

FIG. 7 illustrates a method for combating spyware, malware, etc., in accordance with another embodiment.

### DETAILED DESCRIPTION

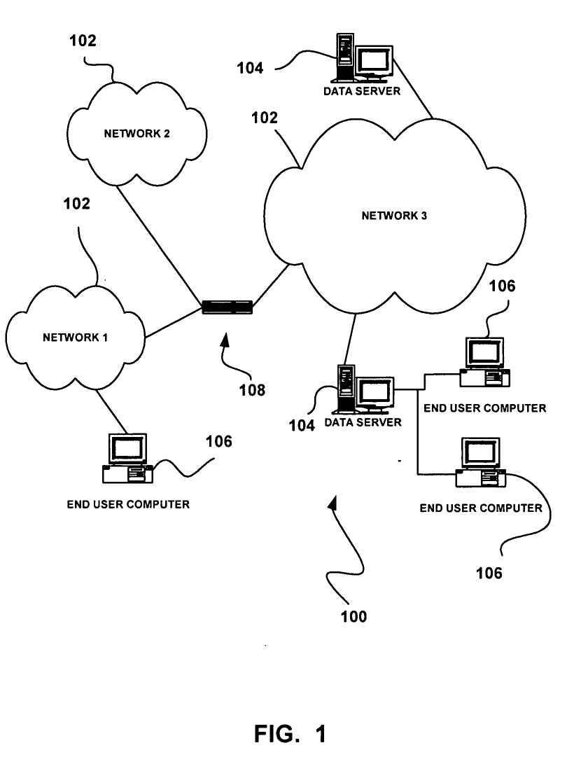

FIG. 1 illustrates a network architecture 100, in accordance with one embodiment. As shown, a plurality of networks 102 is provided. In the context of the present network architecture 100, the networks 102 may each take any form including, but not limited to a local area network (LAN), a wide area network (WAN) such as the Internet, etc.

Coupled to the networks 102 are data server computers 104 which are capable of communicating over the networks 102. Also coupled to the networks 102 and the data server computers 104 is a plurality of end user computers 106. In order to facilitate communication among the networks 102, at least one gateway or router 108 is optionally coupled therebetween.

It should be noted that each of the foregoing network devices in the present network architecture 100, as well as any other unillustrated hardware and/or software, may be equipped with various security features. For example, the various data server computers 104 and/or end user computers 106 may be equipped with security functionality in the form of a scanner, a firewall, etc. for purposes that will be set forth hereinafter in greater detail.

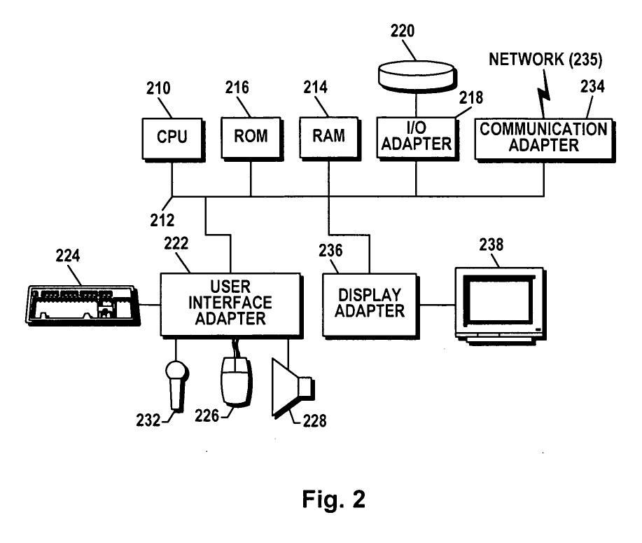

FIG. 2 shows a representative hardware environment that may be associated with the data server computers 104 and/or end user computers 106 of FIG. 1, in accordance with one embodiment. Such figure illustrates a typical hardware configuration of a workstation in accordance with one embodiment having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen (not shown) to the bus 212, communication adapter 234 for connecting the workstation to a communication network 235 (e.g., a data processing network) and a display adapter 236 for connecting the bus 212 to a display device 238.

The workstation may have resident thereon any desired operating system. It will be appreciated that an embodiment may also be implemented on platforms and operating systems other than those mentioned. One embodiment may be written using JAVA, C, and/or C++ language, or other programming languages, along with an object oriented programming methodology. Object oriented programming (OOP) has become increasingly used to develop complex applications.

Our course, the various embodiments set forth herein may be implemented utilizing hardware, software, or any desired combination thereof. For that matter, any type of logic may be utilized which is capable of implementing the various functionality set forth herein.

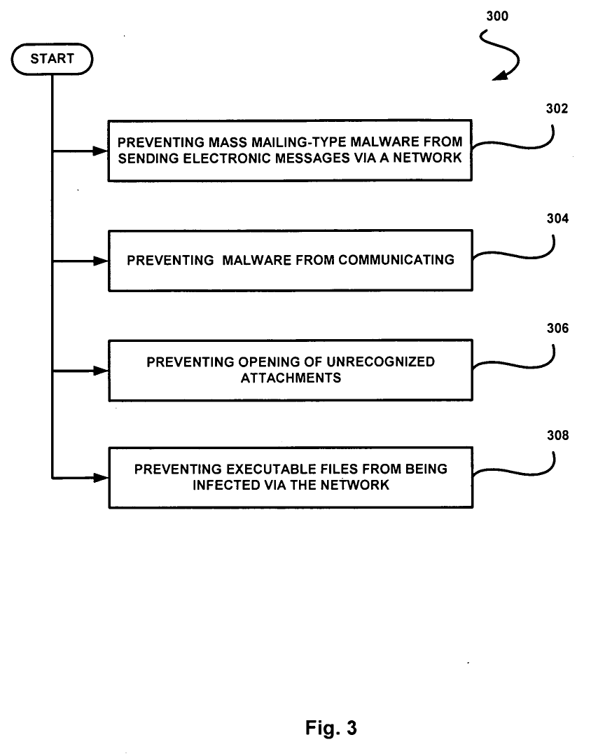

FIG. 3 illustrates a method 300 for preventing malware infection, in accordance with one embodiment. As an option, the present method 300 may be implemented in the context of the architecture and environment of FIGS. 1 and/or 2. Of course, however, the method 300 may be carried out in any desired environment.

It should be noted that the various operations of the method 300 of FIG. 3 may be carried out utilizing a virus scanner and/or any other desired module. Moreover, it should be noted that the order of the various operation may be interchanged and the operations may be executed in parallel, per the desires of the user.

In operation 302, mass-mailing-type malware is prevented from sending electronic messages via a network. In the context of the present description, malware (i.e. “malicious software”) may refer to any programming or files that are developed for the purpose of doing harm to a computer and/or network components. Thus, malware may include, but is not limited to, computer viruses, worms, Trojan horses, etc.

In one embodiment, the mass-mailing-type malware may be capable of sending a multiplicity of electronic messages to a multiplicity of recipients. Further, the mass-mailing-type malware may be prevented from sending electronic messages by preventing use of a predetermined port. This predetermined port may include port 25.

As an option, the mass-mailing-type malware may be prevented from sending electronic messages by utilizing a white list for conditionally preventing the sending of electronic messages based on a predetermined aspect. For example, such a predetermined aspect may include a recipient address or an application identifier.

Some of the most successful recent viruses were those that talked directly with e-mail servers to send themselves to other people. This communication happens on TCP/IP port 25. Thus, by containing a rule which prevents any application from opening port 25, the present embodiment may provide enhanced security. If a virus evades the other rules and is not detected by virus signatures, it may be able to run, but will not be able to spread to any other systems by e-mail.

Because operation 302 will prevent legitimate e-mail clients from sending e-mail, such operation may incorporate the aforementioned white list of known e-mail clients. Sending e-mail is thus limited to a small number of applications that a person uses. In many cases, there may be just one program that is legitimately sending e-mail. This application may further be white listed to prevent false positives.

With reference now to operation 304, the malware is also prevented from communicating. In one embodiment, the malware may be prevented from communicating by preventing communications over predetermined communication channels. Such predetermined communication channels may include, but is not limited to, a file transfer protocol (FTP), a hypertext transfer protocol (HTTP), and/or an internet relay chat (IRC) protocol.

Optionally, the malware may be prevented from communicating by utilizing a white list for conditionally preventing the communicating based on a predetermined aspect. As an example, the predetermined aspect may be an application identifier, etc.

Thus, in one specific aspect of the present embodiment, the present operation prevents viruses and Trojans from communicating. Recent viruses and Trojans have needed to communicate in various ways for various reasons. See, for example, Table 1.

TABLE 1

Some viruses spread in two phases. In the first phase, a
small amount of code spreads to a remote system. This
code then uses FTP to copy the rest of itself over.
Some viruses and Trojans download other Trojans, adware or
spyware using HTTP or FTP.
Some viruses and Trojans inform associated “masters” where
they have spread. They also receive instructions from
associated masters. One common use for this technique is
to set up ‘spam networks.’ In use, the spammer instructs
the infected machines to send spam on his behalf (this
cannot be traced back to him). This communication often
happens using IRC protocol.

The present operation 304 thus utilizes rules which block the aforementioned communication channels. While a system may still become infected, the virus will be stifled if it cannot communicate. As with operation 302, white lists of applications that are allowed to communicate may be employed.

As an option, there may be a few more applications which use the aforementioned communication channels. For example, someone may be using MS Internet Explorer®, MS Outlook®, and/or MS Windows Media Player®, all of which use HTTP to download content. Thus, the risk of false positives may be higher until the user tunes the rules to his/her environment. Once tuned, however, the triggering of the rules may accurately identify unauthorized downloads.

Still yet, in operation 306, unrecognized attachments are prevented from opening. Optionally, the opening of unrecognized attachments may be prevented by preventing the opening of the unrecognized attachments when residing in a temporary directory.

The prevention of the opening of the unrecognized attachments may further be subject to user tuning. For example, such user tuning may involve limiting the prevention of the opening of the unrecognized attachments to situations where the unrecognized attachments are received via a web page or via an electronic message (i.e. e-mail, etc.).

As an option, operation 306 may work to prevent web browsers and/or e-mail clients from executing unknown attachments. The success of the mass-mailing viruses described above can be attributed to the continuing propensity of people to open attachments that they receive in their mailboxes. Because files have to exist on disk before they can be executed, web browsers and e-mail clients save the attachment to the system or the user “temp” directory and are then launched from there.

Thus, the present operation 306 employs rules which prevent common web browsers, e-mail clients and archive extracting programs from launching executables directly from any “temp” directory. In the context of the present description, a temporary directory is any directory that is temporary in nature or in any related aspect (i.e. either in name or function).

In operation 308, executable files are prevented from being infected via the network. In one embodiment, executable files may be prevented from being infected via the network by determining whether a request to open the executable files is a local request or a remote request. In this embodiment, the executable files may be prevented from being infected by conditionally allowing the opening thereof based on whether the request is the local request or the remote request.

A very successful class of viruses is that which spreads across corporate networks by finding writable shares and infecting executables that they find there. As an option, operation 308 may differentiate between open requests made on behalf of another computer on the network, and thus optimally prevent executable files from being infected over the network. More information regarding such differentiation may be found in the aforementioned related application, which is incorporated herein by reference.

Because of such differentiation, operation 308 can still allow local processes to modify executables which, although sometime suspicious, can occur legitimately (i.e. for example, when operating system patches are applied). In one embodiment, the ability to differentiate between local and network accesses may be used in a way that minimizes false positives, by using various related rules that are tuned to specific directories. See Table 2 for examples of such location-based rules.

TABLE 2

On a workstation: it is legitimate for ‘windows update’ to
update executables. It is not legitimate for anyone on
the network to update any executable. A rule is thus
provided which “stops network users from changing any
executable.”
On a fileserver: the comment above about ‘windows update’
is still true. However, it is okay for users on the
network to change some executables (i.e. those in
directories that are meant to be shared, etc.). However,
it is still not legitimate for user to change executables
which belong to the operating system. Rules are provided
which enforce this (i.e. “stop network users from changing
any executable in the directory <c:\windows> and in
subdirectories”).

The ability to tune the aforementioned rules to specific processes minimizes false positives. Obviously, a rule which said “don't allow anything to execute anything” would be 100% secure, but would make the computer useless. By limiting behavior blocking to just those operations which are most dangerous (i.e. running programs from e-mails or web pages), one can stop the casual execution of viruses while still allowing all other legitimate programs to run.

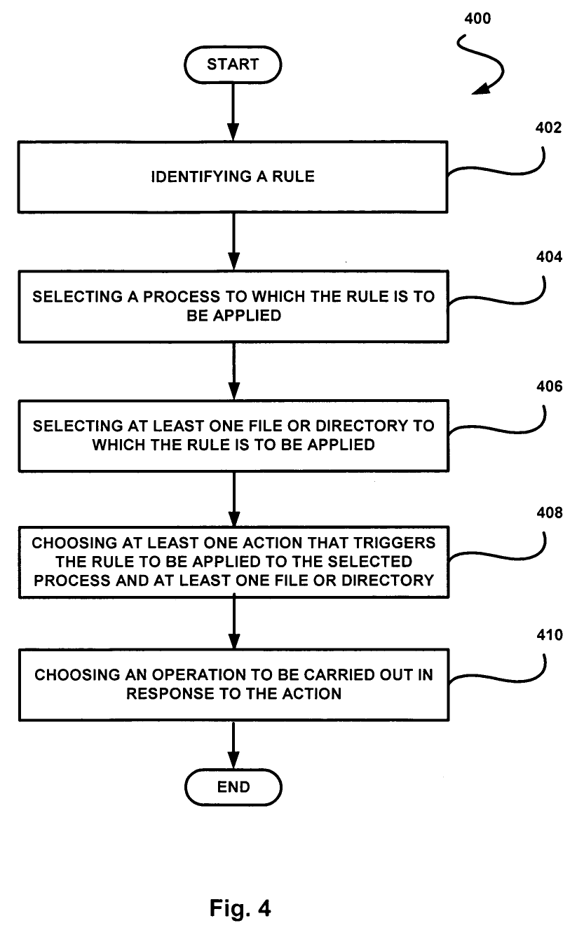

FIG. 4 illustrates a method 400 for defining a rule to prevent malware infection, in accordance with one embodiment. As an option, the present method 400 may be implemented in the context of the architecture and environment of FIGS. 1 and/or 2, and/or in the definition of the rules of the method 300 of FIG. 3. Of course, however, the method 400 may be carried out in any desired environment.

In operation 402, a rule is identified. This may be accomplished in any desired manner. For example, a pre-existing or new name may be selected by the user to later identify the rule.

Further, in operations 404 and 406, a process and at least one file or directory is selected to which the rule is to be applied. In the context of the present description, such process may include any functionality associated with code (i.e. an application program, etc.), and the file may include any data that may be stored at a certain location in memory (i.e. directory).

Still yet, in operation 408, at least one action is chosen that triggers the rule to be applied to the selected process and the at least one file or directory. Such action may include either user or computer actions. Even still, in operation 410, an operation is chosen to be carried out in response to the action. Such operation may include any response that is desired, in dealing with the aforementioned action for security purposes.

The present method 400 thus allows the definition of a powerful rule-based mechanism that can be used to not only prevent a computer from becoming infected with a virus that traditional virus scanning components cannot detect, but also prevent an already infected computer from spreading the infection further or from becoming damaged.

More information regarding one exemplary graphical user interface will now be set forth, which may optionally be used to implement the foregoing method 400, in the context of an illustrative, non-limiting example.

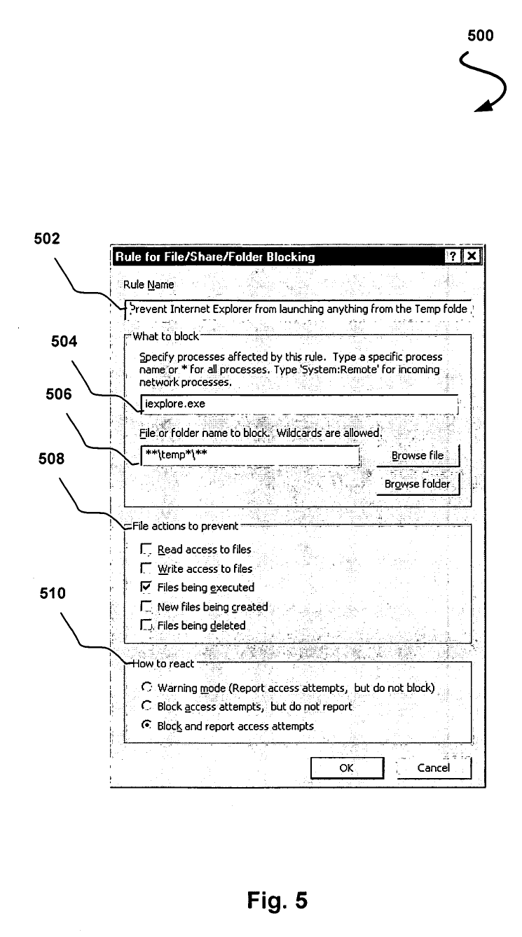

FIG. 5 illustrates an exemplary graphical user interface 500 for defining a rule to prevent malware infection, in accordance with one embodiment. As an option, the present graphical user interface 500 may be implemented in the context of the architecture and environment of FIGS. 1 and/or 2, and/or in the definition of the rules of the methods 300 and 400 of FIGS. 3 and 4. Of course, however, the graphical user interface 500 may be carried out in any desired environment.

As shown in FIG. 5, a first field 502 associated with the graphical user interface 500 is provided. The first field 502 is adapted for receiving a rule identifier (i.e. see, for example, operation 402, of FIG. 4, etc.).

Thus, in one embodiment, this field may simply be used for entering a descriptive name for the rule. If the rule is broken, the rule name may be included in the logs and events that are generated.

Further shown is a second field 504 associated with the graphical user interface 500. In use, the second field 504 is adapted for receiving a selection of a process to which the rule is to be applied (i.e. see, for example, operation 404, of FIG. 4, etc.).

Thus, the present field includes the name(s) of the processes covered by the rule. This can be a single name or cover more than one process through the use of wildcards. It should be understood that the concept of ‘process name’ can readily be extended to lists (i.e. ‘winword.exe,’ ‘excel.exe,’ etc.), directories (i.e. conceptually “everything installed in c:\program files,” etc.), and subdirectories, etc.

Additionally, this feature may optionally be expanded beyond processes, per se, to other entities that can be represented as such (which are intended to fall within the term “processes,” in the present context). For example, two pseudo-processes may be utilized: ‘System:Remote’ which represents file accesses made by the kernel on behalf of clients on the network, and ‘System’ which represents all other files access made by the kernel. More information regarding such feature may be found in the aforementioned related application, which is incorporated herein by reference.

Still yet, a third field 506 is associated with the graphical user interface 500. The third field 506 is adapted for receiving a selection of at least one file or directory to which the rule is to be applied (i.e. see, for example, operation 406, of FIG. 4, etc.).

This field receives the name of the files and/or directories that are covered by the rule. These are not necessarily files that are ‘protected’, or even exist. More information regarding this field will be set forth hereinbelow in the context of a couple of examples. As with the process name, the format to specify the names of files may involve a block that could vary between implementations.

With continuing reference to FIG. 5, a fourth field 508 is associated with the graphical user interface 500. The fourth field 506 is adapted for receiving a selection of at least one action that triggers the rule to be applied to the selected process and at least one file or directory (i.e. see, for example, operation 408, of FIG. 4, etc.).

The present actions may be those that trigger the rule if the named process(es) attempts such actions. Of course, numerous actions may be performed on a file. Some actions such as ‘write data to the file’ cannot occur until another operation (i.e. ‘open file for write access’) has occurred. Since the present embodiment may be monitoring ‘open file for write access,’ such embodiment does not need to offer ‘write data to the file’ as an option to block. Other operations such as ‘rename file’ are conceptually similar to the ones listed and the present embodiment may hide the distinction. Therefore, the list shown is not a definitive list of operations and other implementations may have variations.

When a file operation is attempted, the present embodiment gathers the name of the process that attempted the operation, the name of the directory/file, and the action that was attempted. This information may then be compared against each rule in turn. If all three pieces of information match, the operation is failed and the present embodiment may log all the pertinent information.

Even still, a fifth field 510 is associated with the graphical user interface 500. The fifth field 510 is adapted for receiving a selection of an operation to be carried out in response to the action (i.e. see, for example, operation 410, of FIG. 4, etc.).

Following are possible examples of use of the graphical user interface 500, which are set forth for illustrative purposes only and should not be construed as limiting in any manner.

### EXAMPLE 1

One has a private file (c:†MyData\CreditCard.xls) that one does not want to share. One can protect this file with the rule:

| | |
|---|---|
| Process | System:Remote |
| Filename | C:\MyData\CreditCard.xls |
| Prevent | ‘Open for read access’ |

Remote is a pseudo process that represents file accesses made on behalf of computers on the network. If someone on the network attempts to open or copy this file, the process, filename and action will match those listed in the rule and the attempt will be denied.

### EXAMPLE 2

One hears of a new virus that spreads using the filename ‘virus.exe’. One can prevent this file being created with the rule:

| | |
|---|---|
| Process | * |
| Filename | virus.exe |
| Prevent | Create |

In this case, virus.exe is not being protected—the computer is being protected from this file. It does not matter which process attempts to create the file. Any attempt to create it will fail.

More information will now be set forth regarding one exemplary embodiment utilizing various optional features each of which may (or may not) be incorporated with the foregoing technology of FIGS. 1-5, per the desires of the user.

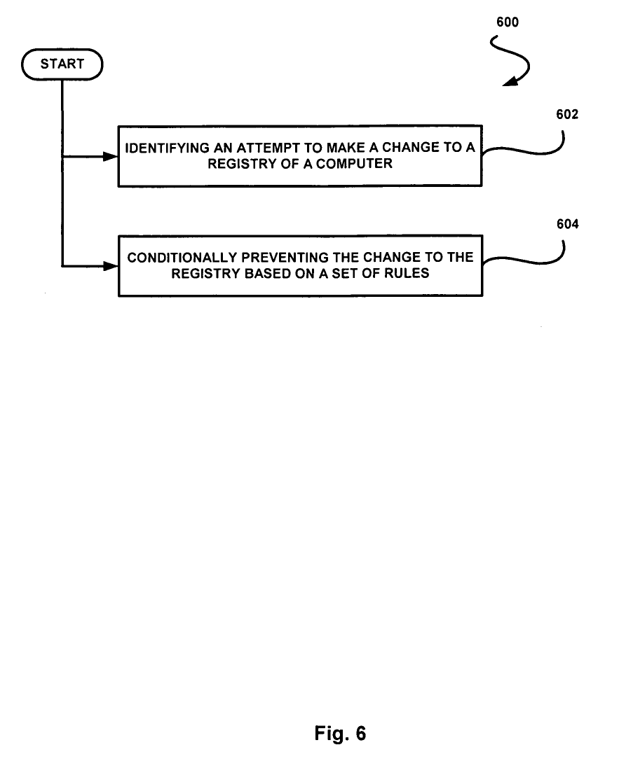

FIG. 6 illustrates a method 600 for combating spyware, malware, etc., in accordance with one embodiment. As an option, the present method 600 may be implemented in the context of the architecture and environment of FIGS. 1 and/or 2, and/or the functionality outlined in FIGS. 3-5. Of course, however, the method 600 may be carried out in any desired environment.

In the context of the present description, malware (i.e. “malicious software”) may refer to any programming or files that are developed for the purpose of doing harm to a computer and/or network components. Thus, malware may include, but is not limited to various forms of computer viruses, worms, Trojan horses, etc. Further, as mentioned previously, in the context of the present description, the term spyware is deemed to include spyware, adware, dialer software, other equivalents, and/or any other software that is less malicious than conventional malware, etc.

As shown, in operation 602, an attempt to make a change to a registry of a computer (e.g. see computers 104, 106 of FIG. 1, for example, etc.) is first identified. This attempted change can be identified in any desired way that identifies any attempted alteration, modification, adjustment, variation, etc. in the registry.

In one embodiment, the registry may include a location on the computer for storing information such as hardware that is attached to the computer, system options that have been selected, a configuration of memory of the computer, and/or application programs to be present when an operating system of the computer is started. In the specific context of the Microsoft® Windows® operating system, the registry may include the sections noted in Table 3.

TABLE 3

HKEY_Classes_Root - file associations and OLE
information
HKEY_Current_User - all preferences set for current
user
HKEY_User - all the current user information for
each user of the system
HKEY_Local_Machine - settings for hardware,
operating system, and installed applications
HKEY_Current_Configuration - settings for the
display and printers
HKEY_Dyn_Data - performance data

Of course, in the context of the present description, the registry may include any data used by an operating system to store configuration information.

Then, in operation 604, the change to the registry is conditionally prevented based on a set of rules. By this operation; spyware, malware, etc. may be combated by preventing any changes to the registry that may facilitate the installation, operation and/or any other aspect of such software.

More information will now be set forth regarding one particular embodiment utilizing various optional features each of which may (or may not) be incorporated with the foregoing method 600 of FIG. 6, per the desires of the user.

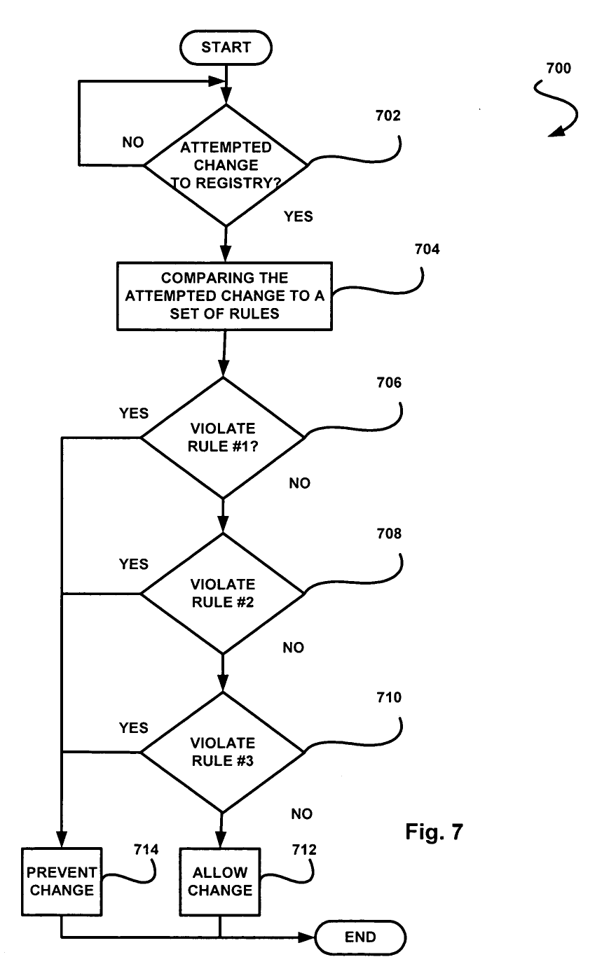

FIG. 7 illustrates a method 700 for combating spyware, malware, etc., in accordance with another embodiment. As an option, the present method 700 may be implemented in the context of the architecture and environment of FIGS. 1 and/or 2, and/or the functionality outlined in FIGS. 3-6. Of course, however, the method 700 may be carried out in any desired environment.

As shown in decision 702, an attempt to change the registry is identified. Monitoring of such attempts may be carried out in any desired manner. It is possible, for example, to provide a filter driver for the registry which operates in a manner similar to a file system filter, in order to detect and control any attempted changes to the registry.

Again, the aforementioned attempted change can be identified in any desired way that identifies any attempted alteration, modification, adjustment, variation, etc. in the registry. Of course, other more specific attempted changes may be monitored. For example, an attempt to make the change to the registry may be received from an application program. Further, such attempt to make the change to the registry may involve a request to an operating system of the computer. Still yet, the change may involve a write value operation, a change value operation, a delete value operation, a create subkey operation, a change subkey operation, etc.

Next, the attempted change is compared to a set of rules. Note operation 704. In one embodiment, the rules may involve a name of a process requesting the change, a name of a key in the registry that is being changed, a name of a value in the registry that is being changed, a type of the change, data that is being written to the registry, etc. Further, the rules may further involve keys such as those set forth in Table 4.

TABLE 4
HKLM\software\microsoft\windows\currentversion\run,
HKLM\SOFTWARE\Microsoft\Windows NT\CurrentVersion\Winlogon,
and/or
KLM\software\microsoft\windows\currentversion\explorer\browser
helper objects.

Of course, any desired rules may be incorporated. See, for example, the rules set forth during the discussion of FIGS. 3-5. For that matter, any of the functionality of FIGS. 3-5 (and the descriptions thereof) may optionally be incorporated with the present embodiment.

In any case, based on the aforementioned comparison of operation 704, it is determined, in decisions 706-710, whether the attempted change(s) violates one or more rules. If any one of the rules is violated, the change is prevented, as indicated in operation 714. If, however, none of the rules is violated, the change may be permitted in operation 712. Three exemplary rules are set forth in Table 5. Of course, such rules are set forth for illustrative purposes only and should not be construed as limiting in any manner. Further, while three decisions (706-710) are shown in FIG. 7, it should be noted that any number (e.g. 1 . . . n) of rules may be utilized in the context of the present embodiment.

TABLE 5
1)

| | |
|---|---|
| Process | All |
| Key name | HKLM\software\microsoft\windows\currentversion\run |
| Value name | All |
| Prevent | write value, change value. |

2)

| | |
|---|---|
| Process | All except winlogon.exe |
| Key name | HKLM\SOFTWARE\Microsoft\Windows NT\ |
| | CurrentVersion\Winlogon |
| Value name | All |
| Prevent | write value, change value, delete value |

3)

| | |
|---|---|
| Process | All |
| Key name | HKLM\software\microsoft\windows\ |
| | currentversion\explorer\browser helper objects |
| subkey name | All |
| Prevent | create subkey, change subkey |

In the context of rule #1 in Table 5, for example, all processes that attempt to make changes to the registry may be subject to such rule. Moreover, the key name that may be monitored is as follows: HKLM\software\microsoft\windows\currentversion\run. Further, any value that is associated with such key is monitored. Finally, if any process attempts to either write or change any value with respect to the foregoing key, such attempt may violate the present rule, resulting in the prevention of the change, per operation 714.

In the context of rule #2, all processes (except winlogon.exe) that attempt to make changes to the registry may be subject to such rule. Moreover, the key name that may be monitored is as follows: HKLM\SOFTWARE\Microsoft\Windows NT\CurrentVersion\Winlogon. Further, any value that is associated with such key is monitored. Finally, if any process attempts to either write, change or delete any value with respect to the foregoing key, such attempt may violate the present rule, resulting in the prevention of the change, per operation 714.

Finally, in the context of exemplary rule #3, all processes that attempt to make changes to the registry may be subject to such rule. Moreover, the key name that may be monitored is as follows: HKLM\software\microsoft\windows\currentversion\explorer\browser helper objects. Further, any subkey that is associated with such key is monitored. Finally, if any process attempts to either create or change any subkey with respect to the foregoing key, such attempt may violate the present rule, resulting in the prevention of the change, per operation 714.

Thus, the change may be prevented for any of a plurality of reasons involving combating spyware, malware, etc. For example, the change may be prevented for precluding installation, execution, etc. of spyware, malware, etc. on the computer.

Because typical spyware (and much malware, for that matter) needs to run all the time and not just when the user chooses the spyware to run, the spyware may need to find a way to coerce the operating system into running the same, for example, when the computer is actuated. On the Microsoft® Windows® operating systems, this procedure involves setting a value at some place in the registry which points to one of the spyware application files. For example, there is a key called HKLM\Software\Microsoft\Windows\CurrentVersion\Run. If a value is created in association with such key which contains the name of an executable file (e.g. the spyware executable, etc.), the operating system automatically runs such executable file when a user logs on to the computer. Thus, the present embodiment exploits the need for such change, for the purpose of improved management of malware, spyware, etc.

To this end, when an application makes a request to an operating system to make a change to a registry, a filter driver may identify the request first and then allow or reject it based on a set of rules. Not only can these rules prevent the installation/execution of spyware and malware, etc., such rules can also prevent some of the other symptoms that such unwanted software can cause, and trigger scans of the files and/or processes that are requesting a registry change.

In one embodiment, terrorism may be countered utilizing the aforementioned technology. According to the U.S. Federal Bureau of Investigation, cyber-terrorism is any “premeditated, politically motivated attack against information, computer systems, computer programs, and data which results in violence against non-combatant targets by sub-national groups or clandestine agents.” A cyber-terrorist attack is designed to cause physical violence or extreme financial harm. According to the U.S. Commission of Critical Infrastructure Protection, possible cyber-terrorist targets include the banking industry, military installations, power plants, air traffic control centers, and water systems. Thus, by optionally incorporating the present technology into the cyber-frameworks of the foregoing potential targets, terrorism may be countered by preventing the infection thereof with malware, which may potentially cause extreme financial harm.

While various embodiments have been described above, it should be understood that they have been presented by way of example only, and not limitation. For example, any of the network elements may employ any of the desired functionality set forth hereinabove. Thus, the breadth and scope of a preferred embodiment should not be limited by any of the above-described exemplary embodiments, but should be defined only in accordance with the following claims and their equivalents.

What is claimed is:

1. A method, comprising:
identifying an attempt to make a change to a registry of a computer; and
conditionally preventing the change to the registry based on a set of rules.

2. The method as recited in claim 1, wherein the attempt to make the change to the registry is received from an application program.

3. The method as recited in claim 1, wherein the attempt to make the change to the registry involves a request to an operating system of the computer.

4. The method as recited in claim 1, wherein the rules involve a name of a process requesting the change.

5. The method as recited in claim 1, wherein the rules involve a name of a key in the registry that is attempted to be changed.

6. The method as recited in claim 1, wherein the rules involve a name of a value in the registry that is attempted to be changed.

7. The method as recited in claim 1, wherein the rules involve a type of the change.

8. The method as recited in claim 1, wherein the rules involve data that is attempted to be written to the registry.

9. The method as recited in claim 1, wherein the change involves a write value operation.

10. The method as recited in claim 1, wherein the change involves a change value operation.

11. The method as recited in claim 1, wherein the change involves a delete value operation.

12. The method as recited in claim 1, wherein the change involves a create subkey operation.

13. The method as recited in claim 1, wherein the change involves a change subkey operation.

14. The method as recited in claim 1, wherein the rules involve a key including HKLM\software\microsoft\windows\currentversion\run.

15. The method as recited in claim 1, wherein the rules involve a key including HKLM\SOFTWARE\Microsoft\Windows NT\CurrentVersion\Winlogon.

16. The method as recited in claim 1, wherein the rules involve a key including HKLM\software\microsoft\windows\currentversion\explorer\browser helper objects.

17. The method as recited in claim 1, wherein the change is prevented for precluding installation of spyware on the computer.

18. The method as recited in claim 1, wherein the change is prevented for precluding installation of malware on the computer.

19. The method as recited in claim 1, wherein the registry includes a location on the computer for storing information selected from a group consisting of hardware that is attached to the computer, system options that have been selected, a configuration of memory of the computer, and application programs to be present when an operating system of the computer is started.

20. The method as recited in claim 1, wherein the registry includes a location on the at least one computer for storing information including hardware that is attached to the computer, system options that have been selected, a configuration of memory of the computer, and application programs to be present when an operating system of the computer is started.

21. The method as recited in claim 1, wherein the method is utilized to counter terrorism.

22. A computer program product embodied on a computer readable medium, comprising:
computer code for identifying an attempt to make a change to a registry of a computer; and
computer code for conditionally preventing the change to the registry based on at least one rule.

23. A system, comprising:
logic for identifying an attempt to make a change to a registry of a computer; and
logic for conditionally preventing the change to the registry based on a set of rules.
